(19) United States
(12) Patent Application Publication
(10) Pub. No.: US 2013/0106696 A1
(43) Pub. Date: May 2, 2013

(54) DISPLAY DEVICE AND INFORMATION TRANSMISSION METHOD

(71) Applicant: Masahiro Ozawa, Tokyo (JP)

(72) Inventor: Masahiro Ozawa, Tokyo (JP)

(21) Appl. No.: 13/560,672

(22) Filed: Jul. 27, 2012

(30) Foreign Application Priority Data
Oct. 28, 2011 (JP) 2011-237953

(51) Int. Cl. G06F 3/033

(52) U.S. Cl. 345/158

(57) ABSTRACT

According to one embodiment, an information transmission method includes: acquiring imaged image information; displaying the imaged image information acquired, including thumbnail image information that indicates first data and a first display area that represents a communication device to which data can be transmitted; detecting a movement of a first object imaged based on the imaged image information acquired; first receiving selection of the thumbnail image information; first determining, by a first determining module, whether a first coordinate value that indicates the first object, the movement of which is detected, is included in the first display area; and transmitting the first data indicated by the thumbnail image information, the selection of which is received, to the communication device represented by the first display area if the first determining module determines that the first coordinate value is included in the first display area.

### CROSS-REFERENCE TO RELATED APPLICATIONS

This application is based upon and claims the benefit of priority from Japanese Patent Application No. 2011-237953, filed on Oct. 28, 2011, the entire contents of which are incorporated herein by reference.

### FIELD

Embodiments described herein relate generally to a display device and an information transmission method.

### BACKGROUND

With the development of television display devices, a technique is proposed in which a television display device records program content supplied through broadcast or distributed over a network and provides such program content upon a request from a user.

A trend in late years, in particular, is that the augmented reality (AR) technology is gaining attention. AR is a technique that superimposes a virtual environment over an actual environment.

The AR is proposed to be applied to various techniques. For example, the AR is proposed to be combined with a technique that detects the position or the movement of a person using, for example, a camera. The proposed technique is to provide various types of information based on the position or the movement of the person detected in the actual environment over which the virtual environment is superimposed. An exemplary proposed technique is to change information to be displayed on a display device dynamically according to the movement of the person detected.

The conventional technology is, however, concerned only with operating a device that can detect the position or the movement of a person, and not with operating another device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an example of a content use system according to a first embodiment;

FIG. 2 is an exemplary block diagram illustrating a main signal processing system of a television display device in the embodiment;

FIG. 3 is an exemplary diagram illustrating a software configuration achieved when an AR application is performed by a controller in the embodiment;

FIG. 4 is an exemplary diagram illustrating a relationship between an exemplary screen displayed by a display controller and a tablet terminal 150 in the embodiment;

FIG. 5 is an exemplary diagram illustrating an exemplary screen displayed by the display controller after an object of selection is received by a selector in the embodiment;

FIG. 6 is an exemplary diagram illustrating states of the television display device in the embodiment changed according to a movement of a person's hand;

FIG. 7 is an exemplary diagram illustrating an example in which program content is transmitted to the tablet terminal from a transmitter in the embodiment;

FIG. 8 is an exemplary flowchart illustrating a process for transmitting and receiving program content in the television display device and the tablet terminal in the embodiment;

FIG. 9 is an exemplary flowchart illustrating a process for transmitting and receiving characteristic information in the television display device and the tablet terminal in the embodiment;

FIG. 10 is an exemplary diagram illustrating an exemplary screen displayed on a television display device according to a second embodiment;

FIG. 11 is an exemplary diagram illustrating a software configuration achieved when an AR application is performed by a controller in the embodiment;

FIG. 12 is an exemplary diagram illustrating a table structure of a terminal information storage in the embodiment; and

FIG. 13 is an exemplary flowchart illustrating a process followed by a television display device 900 in the embodiment to transmit program content.

### DETAILED DESCRIPTION

In general, according to one embodiment, a display device comprises: an acquiring module configured to acquire, from an imaging device that images an object, imaged image information; a display controller configured to display the imaged image information acquired by the acquiring module, including thumbnail image information that indicates first data and a first display area that represents a communication device to which data can be transmitted from the display device; a detector configured to detect a movement of a first object imaged by the imaging device based on the imaged image information acquired by the acquiring module; a selector configured to receive selection of the thumbnail image information; a first determining module configured to determine whether a first coordinate value that indicates the first object, the movement of which is detected by the detector, is included in the first display area; and a transmitter configured to transmit the first data indicated by the thumbnail image information, the selection of which is received by the selector, to the communication device represented by the first display area if the first determining module determines that the first coordinate value is included in the first display area.

Embodiments to be given hereunder describe an example in which a display device and an information transmission method are applied to a television display device.

### First Embodiment

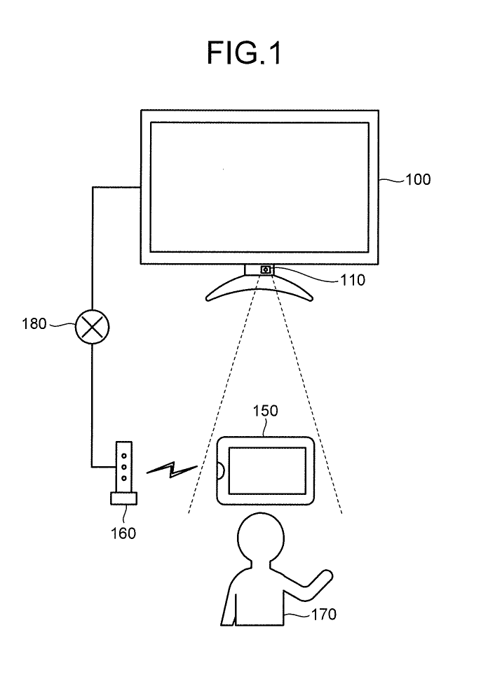

FIG. 1 is an exemplary diagram illustrating an example of a content use system according to a first embodiment. The content use system illustrated in FIG. 1 comprises a television display device 100 connected via a home wireless or wired network 180, a wireless router 160, and a tablet terminal 150. The wireless router 160 connects the tablet terminal 150 to the home network 180 through wireless communication with the tablet terminal 150. This enables communication between the television display device 100 and the tablet terminal 150.

For example, the television display device 100 functions as a DNLA server and the tablet terminal 150 functions as a DNLA client. The first embodiment will be described for an example in which program content is supplied from the television display device 100 to the tablet terminal 150. The embodiment is nonetheless not limited to the television display device and the tablet terminal. For example, a PC or the like that functions as a DNLA server may be incorporated instead of the television display device. Furthermore, a portable communication terminal or a portable PC that functions as a DNLA client, for example, may be incorporated instead of the tablet terminal.

In the first embodiment, the television display device 100 records program content provided by broadcast or distributed via a network. The television display device 100 thereby provides the tablet terminal 150 with the recorded program content.

The television display device 100 comprises a camera 110. In addition, the television display device 100 stores therein an AR application. The AR application detects a movement of a person 170 according to imaged image data imaged by the camera 110. The AR application operates the program content based on the movement detected and transmits the program content to the tablet terminal 150 via the home network 180.

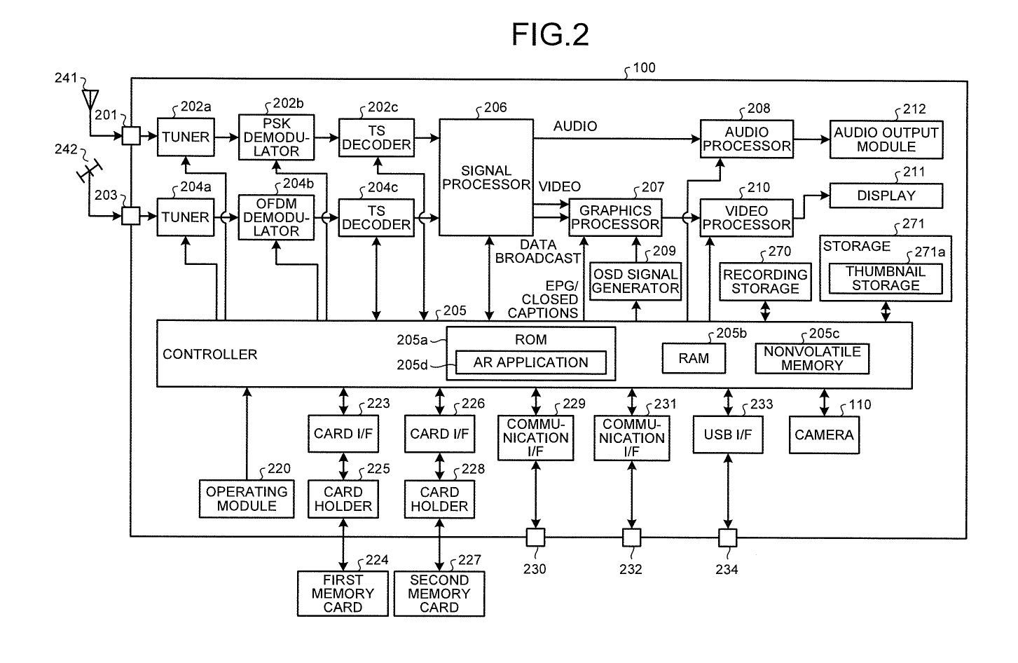

A hardware configuration of the television display device 100 will be described below. FIG. 2 is a block diagram illustrating a main signal processing system of the television display device 100 in the first embodiment.

A satellite digital television broadcast signal received by a BS/CS digital broadcast receiving antenna 241 is supplied to a satellite digital broadcast tuner 202a via an input terminal 201.

The tuner 202a tunes in to a broadcast signal of a desired channel using a control signal from a controller 205 and outputs the tuned broadcast signal to a phase shift keying (PSK) demodulator 202b.

The PSK demodulator 202b demodulates the broadcast signal tuned by the tuner 202a using a control signal from the controller 205 to thereby acquire a transport stream (TS) including a desired program. The PSK demodulator 202b then outputs the TS to a TS decoder 202c.

The TS decoder 202c TS-decodes a transport stream (TS) multiplexed signal using a control signal from the controller 205. The TS decoder 202c then outputs a packetized elementary stream (PES) acquired by depacketizing a digital video signal and a digital audio signal of the desired program to an STD buffer (not illustrated) in a signal processor 206.

The TS decoder 202c outputs section information being transmitted by digital broadcast to a section processing portion (not illustrated) in the signal processor 206.

A terrestrial digital television broadcast signal received by a terrestrial broadcast receiving antenna 242 is supplied to a terrestrial digital broadcast tuner 204a via an input terminal 203.

The tuner 204a tunes in to a broadcast signal of a desired channel using a control signal from the controller 205 and outputs the tuned broadcast signal to an orthogonal frequency division multiplexing (OFDM) demodulator 204b.

The OFDM demodulator 204b demodulates the broadcast signal tuned by the tuner 204a using a control signal from the controller 205 to thereby acquire a transport stream (TS) including a desired program. The OFDM demodulator 204b then outputs the TS to a TS decoder 204c.

The TS decoder 204c TS-decodes a transport stream (TS) multiplexed signal using a control signal from the controller 205. The TS decoder 204c then outputs a packetized elementary stream (PES) acquired by depacketizing a digital video signal and a digital audio signal of the desired program to the STD buffer in the signal processor 206.

The TS decoder 204c outputs the section information being transmitted by digital broadcast to the section processing portion in the signal processor 206.

It is here noted that the signal processor 206 selectively performs predetermined digital signal processing for the digital video signal and the digital audio signal supplied from each of the TS decoder 202c and the TS decoder 204c during watching of television to thereby output resultant signals to a graphics processor 207 and an audio processor 208. Meanwhile, during recording of a program, the signal processor 206 records signals resulting from predetermined digital signal processing selectively performed for the digital video signal and the digital audio signal supplied from each of the TS decoder 202c and the TS decoder 204c in a recording storage (e.g., an HDD) 270 via the controller 205. Similarly, during reproduction of a recorded program, the signal processor 206 performs predetermined digital signal processing for recorded program data read from the recording storage (e.g., the HDD) 270 via the controller 205 to thereby output resultant data to the graphics processor 207 and the audio processor 208.

The controller 205 receives inputs of various types of data, from the signal processor 206, for acquiring a program (such as key information for B-CAS descrambling), electronic program guide (EPG) information, program attribute information (such as program category), closed caption information (such as service information SI or PSI), and the like.

Using the received information, the controller 205 performs image generation processing in order to display the EPG/closed captions and outputs generated image information to the graphics processor 207.

Meanwhile, the controller 205 has a function of controlling recording and programmed or timer recording of a program. During reception of a program for programmed or timer recording, the controller 205 displays the electronic program guide (EPG) information on a display 211. The controller 205 then sets in a storage 271 details of the programmed or timer recording input from a user through an operating module 220 or extracted from the imaged image data imaged by the camera 110.

Then, the controller 205 controls the tuners 202a, 204a, the PSK demodulator 202b, the OFDM demodulator 204b, the TS decoders 202c, 204c, and the signal processor 206 so that the specified program is to be recorded at a set time-of-day according to the details of the programmed or timer recording set in the storage 271.

In addition to storing details of the programmed or timer recording, the storage 271 also comprises a thumbnail storage 271a. The thumbnail storage 271a stores therein thumbnail image data of each piece of program content stored in the recording storage 270.

From among pieces of the section information received from the TS decoder 202c (204c), the section processing portion outputs to the controller 205 various types of data for acquiring a program, electronic program guide (EPG) information, program attribute information (such as program category), closed caption information (such as service information SI or PSI), and the like.

The graphics processor 207 has a function to synthesize the following signals: (1) a digital video signal supplied from an AV decoder (not illustrated) in the signal processor 206; (2) an on screen display (OSD) signal generated by an OSD signal generator 209; (3) image data of data broadcast; and (4) an EPG/closed caption signal generated by the controller 205. The graphics processor 207 then outputs the synthesized signals to a video processor 210.

In addition, when to display a closed-captioned broadcast video or program with closed captions, the graphics processor 207 superimposes the closed caption information over the video signal based on the closed caption information as controlled by the controller 205.

The digital video signal output from the graphics processor 207 is supplied to the video processor 210. The video processor 210 converts the input digital video signal to a corresponding analog video signal in a format displayable on the display 211 and then outputs the analog video signal to the display 211, thereby causing the display 211 to display the video thereon.

The audio processor 208 converts the input digital audio signal to a corresponding analog audio signal in a format reproducible by an audio output module 212. The audio processor 208 then outputs the analog audio signal to the audio output module 212 to thereby reproduce the audio thereon.

The controller 205 comprises a read only memory (ROM) 205a, a random access memory (RAM) 205b that provides a work area for a CPU, and a nonvolatile memory 205c that stores therein, for example, various types of setting information and control information. The controller 205 controls generally the television display device 100.

The controller 205 is connected via a card interface (I/F) 223 to a card holder 225 into which a first memory card 224 can be inserted. This allows the controller 205 to transmit information to or from the first memory card 224 inserted in the card holder 225 through the card I/F 223.

Furthermore, the controller 205 is connected via a card I/F 226 to a card holder 228 into which a second memory card 227 can be inserted. This allows the controller 205 to transmit information to or from the second memory card 227 inserted in the card holder 228 through the card I/F 226.

Additionally, the controller 205 is connected via a communication I/F 229 to a first LAN terminal 230. This allows the controller 205 to transmit information to or from a LAN-compatible device (e.g., an external HDD) connected to the first LAN terminal 230 through the communication I/F 229.

Furthermore, the controller 205 is connected via a communication I/F 231 to a second LAN terminal 232. This allows the controller 205 to transmit information to or from various types of LAN-compatible devices connected to the second LAN terminal 232 through the communication I/F 231.

Additionally, the controller 205 is connected via a USB I/F 233 to a USB terminal 234. This allows the controller 205 to transmit information to or from various types of devices connected to the USB terminal 234 through the USB I/F 233.

Additionally, the controller 205 is connected to the camera 110. This allows the controller 205 to acquire imaged image data imaged by the camera 110.

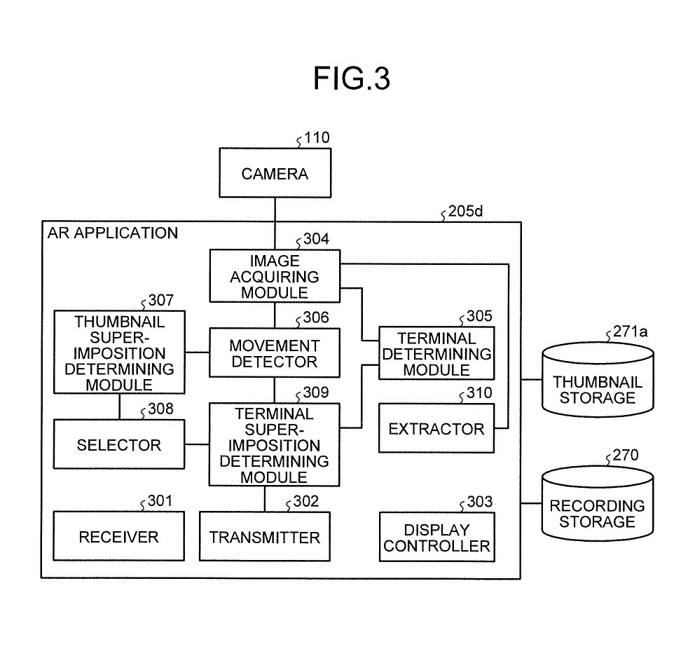

Processing to be performed when an AR application 205d for controlling program content among other control programs stored in the ROM 205a is executed will be described below. FIG. 3 illustrates a software configuration achieved when the AR application 205d is executed by the controller 205.

As illustrated in FIG. 3, the AR application 205d comprises a receiver 301, transmitter 302, a display controller 303, an image acquiring module 304, a terminal determining module 305, a movement detector 306, a thumbnail superimposition determining module 307, a selector 308, a terminal superimposition determining module 309, and an extractor 310.

The receiver 301 receives data from an external device (e.g., the tablet terminal 150) connected over a network to the communication I/F 229 or the communication I/F 231.

The transmitter 302 transmits data to an external device (e.g., the tablet terminal 150) connected over a network to the communication I/F 229 or the communication I/F 231.

The display controller 303 controls display of the display 211 through the video processor 210.

In the first embodiment, when a packet indicating a take-out request is broadcasted from the tablet terminal 150 to the network 180, the receiver 301 receives the take-out request. This causes the controller 205 to activate the AR application 205d. At this time, the receiver 301 receives identification information (e.g., a device name, an IP address, or an MAC address) that identifies the tablet terminal 150 on the network 180. This allows the television display device 100 to identify the tablet terminal 150, so that a communication is established between the television display device 100 and the tablet terminal 150.

Subsequently, the receiver 301 receives characteristic information indicating a characteristic of the appearance of the tablet terminal 150 from the tablet terminal 150.

The characteristic information is information with which a characteristic of the appearance of the tablet terminal 150 can be identified. The characteristic information may be information extracted from imaged image data of the appearance of the tablet terminal 150, including information indicating, for example, a point of interest that indicates the position or orientation of a pixel characteristic of the tablet terminal 150 in the imaged image data. In addition, the characteristic information may be in any one of various formats that are not particularly limited.

The image acquiring module 304 acquires imaged image data from the camera 110 that images an object. The imaged image data may be such that, with the imaged image data, the movement of the object is detectable and may be either moving image data or still image data.

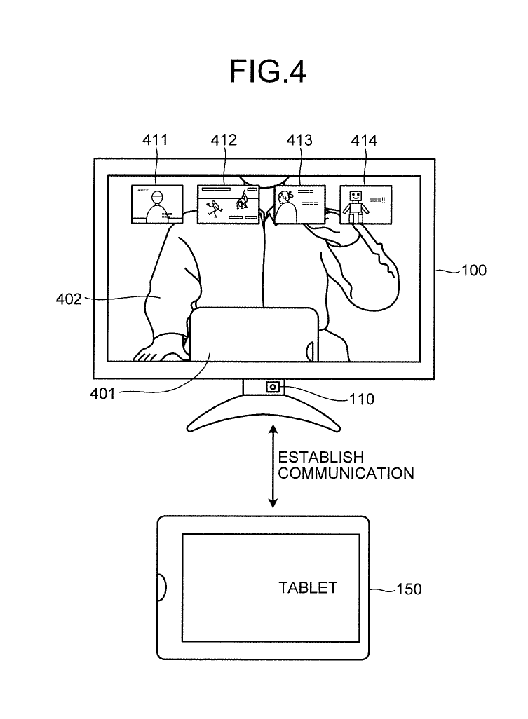

The terminal determining module 305 determines, based on the imaged image data acquired by the image acquiring module 304 and the characteristic information received by the receiver 301, whether the object imaged in the imaged image data is the tablet terminal 150. In the exemplary screen illustrated in FIG. 4, the terminal determining module 305 determines that a display area 401 is a display area in which the tablet terminal 150 as the object is imaged.

Besides conventionally proposed techniques, various other techniques may be employed for matching the characteristic information with the object imaged in the imaged image data. For example, the terminal determining module 305 may perform matching of a point of interest (that indicates the position or orientation of a characteristic pixel within the image) between the characteristic information and the imaged image data, thereby determining whether the object imaged in the imaged image data is the tablet terminal 150 indicated by the characteristic information. Alternatively, after the point of interest within the imaged image data is detected, the terminal determining module 305 may take into consideration, for example, an imaging angle or distance of the object based on the position of the point of interest detected before performing matching with the characteristic information. This allows detection accuracy to be enhanced.

The display controller 303 displays the imaged image data acquired by the image acquiring module 304 on the display 211. The display controller 303 superimposes thumbnail image data that represents program content on a display area on which the imaged image data is displayed. If the terminal determining module 305 has determined that the tablet terminal 150 is imaged in the imaged image data, the imaged image data displayed by the display controller 303 is displayed with the thumbnail image data that represents program content and the display area that represents the tablet terminal 150 included.

FIG. 4 illustrates a relationship between an exemplary screen displayed by the display controller 303 and the tablet terminal 150. In the example illustrated in FIG. 4, the television display device 100 displays the imaged image data imaged by the camera 110, the imaged image data including (the display area 401 of) the tablet terminal and a person 402. As such, the imaged image data includes a plurality of objects ((the display area 401 of) the tablet terminal and the person 402).

The display controller 303 reads thumbnail image data associated with the program content recorded in the recording storage 270 from the thumbnail storage 271a. The display controller 303 then superimposes thumbnail image data items 411, 412, 413, and 414 read over the imaged image data to display the items in a list format.

The movement detector 306 detects the movement of the imaged object (person) based on the imaged image data acquired by the image acquiring module 304. The movement detector 306 in the first embodiment detects the movement of the object (person) based on a difference among a plurality of imaged image data items.

Optical flow, for example, may be employed for detecting movements by the movement detector 306. Optical flow is a technique that tracks a movement of a point (or a pixel) between a first frame and a second frame. The optical flow may be dense or sparse. While the dense optical flow offers high accuracy but requires a high calculation cost, the sparse optical flow requires a low calculation cost. Hence, the sparse optical flow would be the first choice; however, if, for example, a hand is the object of tracking, it is difficult to specify a point suitable for tracking because of variable shapes and orientations involved. Use of the Lucas-Kanade (LK) algorithm that finds a movement relative to a certain small window that surrounds each of a plurality of points of interest in the image allows the movement of the hand by optical flow to be recognized.

In the first embodiment, a center of gravity of a point at which a hand movement is detected is defined as a coordinate value indicating the position of the person's hand.

The transmitter 302 transmits the program content represented by the thumbnail image data to the tablet terminal 150 based on the movement of the person detected by the movement detector 306. Specifically, the following processing is performed.

The thumbnail superimposition determining module 307 determines whether the coordinate value on the imaged image data representing the position of the person's hand identified from the movement detected is included in the display area of the thumbnail image data.

If the movement detector 306 detects a predetermined movement after the thumbnail superimposition determining module 307 determines that the coordinate value indicating the position of the person's hand is included in the display area of the thumbnail image data, the selector 308 receives the program content represented by the thumbnail image data as an object to be transmitted. Examples of the predetermined movement include, but not limited to, pinching in (the thumbnail image data) with the person's fingers and moving the person's hand downwardly (in a direction in which the tablet terminal 150 exists). Specifically, the program content is not selected as long as the person's hand moves laterally. When any given thumbnail image data is superimposed on the display area representing the person's hand and then is pinched in with the person's fingers or the person's hand moves toward the tablet terminal 150, the program content represented by the any given thumbnail image data is selected as an option to be transmitted.

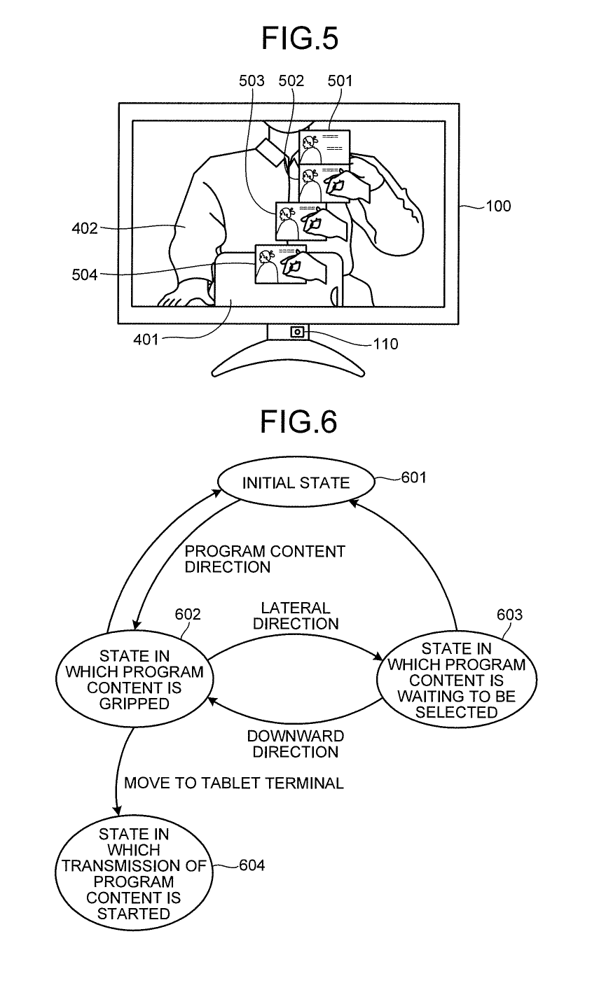

FIG. 5 illustrates an exemplary screen displayed by the display controller 303 after an object of selection is received by the selector 308 in the first embodiment. As illustrated in the exemplary screen of FIG. 5, the display controller 303 displays the thumbnail image data of the program content received for selection by the selector 308 so as to be moved according to the movement of the person's hand detected by the movement detector 306.

As illustrated in the example of FIG. 5, the thumbnail image data is displayed as being moved through display areas 501, 502, 503, and 504, in sequence, in response to the movement of the person's hand.

FIG. 6 illustrates states of the television display device 100 in the first embodiment changed according to the movement of the person's hand. As illustrated in FIG. 6, in the first embodiment, the states include an initial state 601, a state 602 in which the program content is gripped, a state 603 in which the program content is waiting to be selected, and a state 604 in which transmission of the program content is started.

When the person's hand moves from the initial state 601 toward the program content, the television display device 100 shifts into the state 602 in which the program content is gripped (selection is received by the selector 308). It is noted that the television display device 100 may be shifted into the state 602 in which the program content is gripped when the movement of pinching in with fingers is detected.

When the movement of the person's hand in the lateral direction is detected, the television display device 100 shifts from the state 602 in which the program content is gripped to the state 603 in which the program content is waiting to be selected, as a result of the program content gripped being released. Note that the television display device 100 shifts into the initial state 601 after a lapse of a predetermined period of time in the state 602 in which the program content is gripped or the state 603 in which the program content is waiting to be selected.

The television display device 100 shifts into the state 602 in which the program content is gripped when a downward movement of the person's hand superimposed on the program content is detected from the state 603 in which the program content is waiting to be selected.

When, in the state 602 in which the program content is gripped, the person's hand is detected to be included in the display area 401 of the tablet terminal 150, the television display device 100 shifts into a state of transmitting the program content. The terminal superimposition determining module 309 determines whether the person's hand is included in the display area 401 of the tablet terminal 150.

While the thumbnail image data is displayed as being moved in response to the movement of the person's hand, the terminal superimposition determining module 309 determines whether the coordinate value indicating the position of the person's hand detected by the movement detector 306 is included in the display area 401 in which the tablet terminal 150 is being imaged.

When the coordinate value indicating the position of the person's hand is determined to be included in the display area 401 in which the tablet terminal 150 is being imaged, the transmitter 302 transmits the program content represented by the thumbnail image data being displayed as being moved in response to the movement of the person's hand to the tablet terminal 150 being imaged in the display area 401. The identification information (e.g., a device name, an IP address, or an MAC address) received is used for the transmission destination.

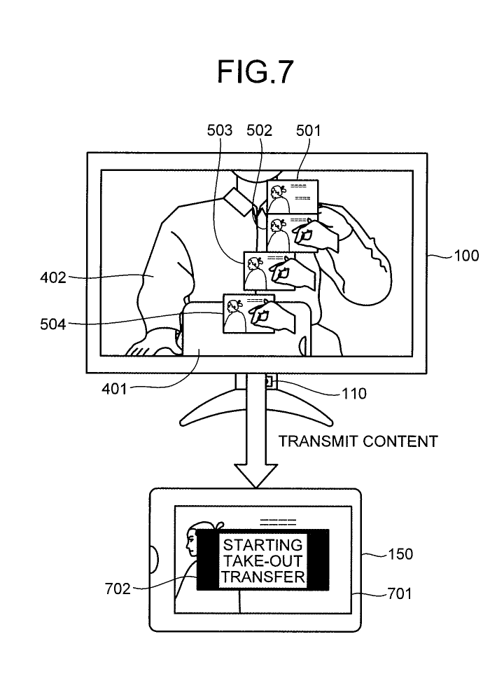

FIG. 7 illustrates an example in which program content is transmitted to the tablet terminal 150 from the transmitter 302 in the first embodiment. As illustrated in FIG. 7, when the coordinate value indicating the position of the person's hand is included in the display area 401 in which the tablet terminal 150 is being imaged, the transmitter 302 transmits the program content for which selection is received by the selector 308 to the tablet terminal 150. At this time, the tablet terminal 150 displays a message 702 indicating that reception of the program content is started. At this time, the tablet terminal 150 displays image data 701 that represents the program content.

A take-out application is installed in advance in the tablet terminal 150 before shipment. In this case, the tablet terminal 150 can store in a storage (e.g., an HDD or an SSD) in advance the characteristic information that allows, for example, the television display device 100 to recognize whether the display device itself is imaged in the image data.

Meanwhile, an application provider may distribute the take-out application via the network or sell the take-out application in a package. In this case, when the take-out application is installed in, for example, the tablet terminal 150, the characteristic information needs to be acquired using, for example, the television display device 100. The television display device 100 according to the first embodiment comprises the extractor 310 in order to transmit the characteristic information to the tablet terminal 150.

If the receiver 301 receives a request for acquiring the characteristic information from the tablet terminal 150, the extractor 310 extracts, from among the imaged image data acquired by the image acquiring module 304, the characteristic information indicating the appearance of an object disposed in front of the camera 110 (e.g., the tablet terminal 150).

The transmitter 302 transmits the characteristic information extracted by the extractor 310 to a communication device (e.g., the tablet terminal 150) from which the request for acquiring the characteristic information has been transmitted.

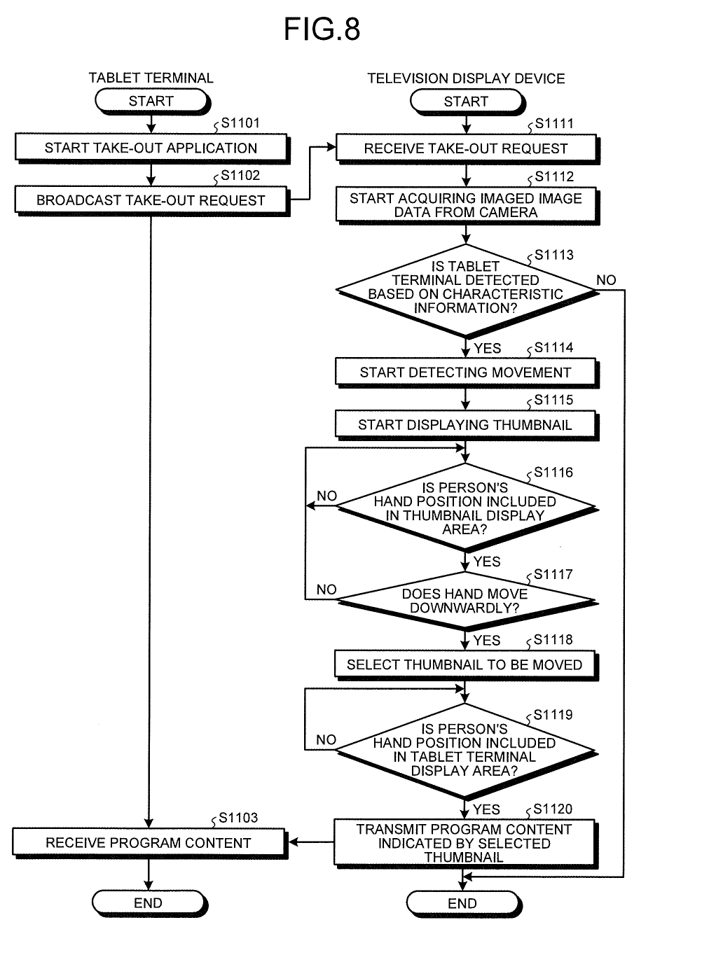

Processing to be performed when the program content is transmitted from the television display device 100 to the tablet terminal 150 according to the first embodiment will be described below. FIG. 8 is a flowchart illustrating a process for transmitting and receiving program content in the television display device 100 and the tablet terminal 150 according to the first embodiment.

In response to an operation by a user, the tablet terminal 150 first starts the take-out application (S1101). Next, the take-out application broadcasts a packet indicating a take-out request (S1102).

The receiver 301 of the television display device 100 receives the take-out request from the tablet terminal 150 (S1111).

The television display device 100 can identify the transmission destination (the tablet terminal 150) of the take-out request using an IP address or a MAC address contained in the take-out request. After communication between the television display device 100 and the tablet terminal 150 is established, the tablet terminal 150 transmits characteristic information to the television display device 100. The tablet terminal 150 then receives the characteristic information. Though the take-out request and the characteristic information are transmitted separately in the first embodiment, the take-out request and the characteristic information may be transmitted at once.

Subsequently, the television display device 100 starts the camera 110 together with the AR application 205d. The camera 110 then shifts into a state for imaging a front surface area of the television display device 100.

Next, the image acquiring module 304 of the AR application 205d starts acquiring the imaged image data from the camera 110 (S1112).

The terminal determining module 305 determines, based on the characteristic information and the imaged image data, whether the tablet terminal 150 is included in the imaged image data (S1113). If the terminal determining module 305 determines that the tablet terminal 150 is not included (No at S1113), the process is terminated.

If the terminal determining module 305 determines that the tablet terminal 150 is included in the imaged image data (Yes at S1113), the television display device 100 recognizes the tablet terminal 150 as a transmission destination of the program content. The movement detector 306 then starts detecting a movement of a person's hand based on the imaged image data (S1114).

The display controller 303 reads thumbnail image data from the thumbnail storage 271a and starts displaying a list of the thumbnail image data superimposed on the upper part of the imaged image data (S1115).

The thumbnail superimposition determining module 307 determines whether the coordinate value indicating the position of the person's hand detected is included in the display area of the thumbnail image data (S1116). If the coordinate value is not included (No at S1116), the process of S1116 is performed again.

The movement detector 306 thereafter determines whether the person's hand detected moves downwardly (S1117). If the person's hand detected does not move downwardly, for example, if the person's hand detected moves laterally (No at S1117), the process is performed again starting with S1116. It is noted that the person's hand may be gripping instead of moving downwardly.

By contrast, if the movement detector 306 determines that the person's hand detected moves downwardly (Yes at S1117), the selector 308 receives the thumbnail image data that last included the coordinate value indicating the position of the person's hand at S1116 for selection as an object to be moved (S1118). This allows the user to select the content from the list of the thumbnail image data.

Subsequently, the terminal superimposition determining module 309 determines whether the coordinate value indicating the position of the person's hand detected by the movement detector 306 is included in the display area 401 in which the tablet terminal 150 is imaged (S1119). If the terminal superimposition determining module 309 determines that the coordinate value is not included (No at S1119), the process of S1119 is performed again.

By contrast, if the terminal superimposition determining module 309 determines that the coordinate value indicating the position of the person's hand is included in the display area 401 in which the tablet terminal 150 is imaged (Yes at S1119), the transmitter 302 transmits to the tablet terminal 150 the program content indicated by the thumbnail image data received for selection by the selector 308 (S1120).

As a result, the tablet terminal 150 receives the program content (S1103).

As described above, if the take-out application is installed in the tablet terminal 150, the tablet terminal 150 is required to acquire the characteristic information from the television display device 100.

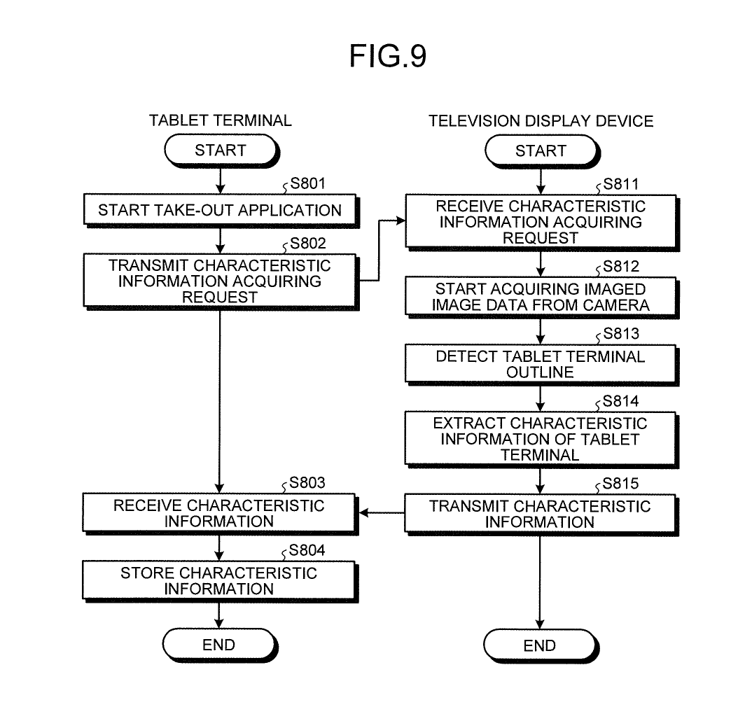

Processing to be performed when the tablet terminal 150 acquires the characteristic information from the television display device 100 according to the first embodiment will be described below. FIG. 9 is a flowchart illustrating a process for transmitting and receiving the characteristic information in the television display device 100 and the tablet terminal 150 in the first embodiment.

The tablet terminal 150 first starts the take-out application in response to an operation by a user (S801). The tablet terminal 150 then transmits a characteristic information acquiring request from the take-out application to the television display device 100 present in front of the tablet terminal 150 (S802). The characteristic information acquiring request may be made, for example, at such timing as when the user presses a “characteristic information acquiring request” button disposed on a display screen of the take-out application.

The receiver 301 of the television display device 100 receives the characteristic information acquiring request from the tablet terminal 150 (S811). The television display device 100 can identify the transmission destination (the tablet terminal 150) of the characteristic information acquiring request using an IP address or a MAC address contained in the take-out request. Communication between the television display device 100 and the tablet terminal 150 is thus established.

Subsequently, the television display device 100 starts the camera 110 together with the AR application 205d. The camera 110 then shifts into a state for imaging a front surface area of the television display device 100.

Next, the image acquiring module 304 of the AR application 205d starts acquiring the imaged image data from the camera 110 (S812).

The extractor 310 detects an outline of the tablet terminal 150 from the imaged image data (S813). The extractor 310 then extracts the characteristic information of the tablet terminal 150 (S814).

Subsequently, the transmitter 302 transmits the characteristic information extracted to the tablet terminal 150 (S815).

The tablet terminal 150 receives the characteristic information (S803). The tablet terminal 150 then stores the characteristic information received in a storage (S804).

The tablet terminal 150 can acquire the characteristic information through the above-described process. This allows the tablet terminal 150 to make a take-out request of program content using the characteristic information.

In the first embodiment, program content is actually transmitted to the tablet terminal by simply dragging the program content to the tablet terminal displayed on the AR (augmented reality), so that intuitive operations can be provided for the user.

When program content is to be transferred between different devices, conventionally characters or icons displayed on the television display device are referred to and an operation is then performed to specify specific devices between which the program content is to be transferred. In contrast, in the above-described embodiment, dragging the thumbnail that represents the program content to a transfer destination communication terminal that is actually imaged on the display screen will start actual transfer, thus enabling an intuitive operation. This allows the user to transfer content easily.

In addition, in the conventional technology, when the image data imaged by a camera built in the communication terminal is displayed on a display panel, an object imaged in the camera is recognized and information is added to the object. However, the conventional technology was not designed to return feedback to the object imaged beyond the camera (the above-described tablet terminal 150). In contrast, in the above-described embodiment, feedback can also be provided for the communication terminal imaged by the camera 110.

### Second Embodiment

The first embodiment has been described for the case in which the program content is transmitted to the tablet terminal 150 imaged by the camera 110. It should be understood that the transmission destination of the program content is not limited only to a device being imaged by the camera 110. In the second embodiment, a technique will be described that selects a specific transmission destination of the program content from among devices previously registered.

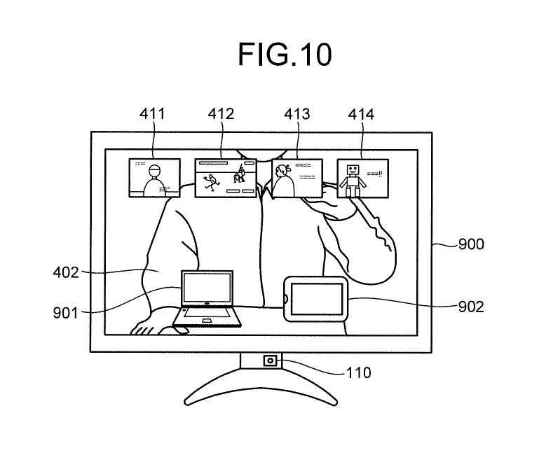

FIG. 10 illustrates an exemplary screen displayed on a television display device 900 according to the second embodiment. As illustrated in FIG. 10, the television display device 900 displays image data items 901 and 902 of communication devices to which program content is to be transmitted (hereinafter referred to as terminal image data items) superimposed on, and in addition to, the thumbnail image data items 411, 412, 413, and 414.

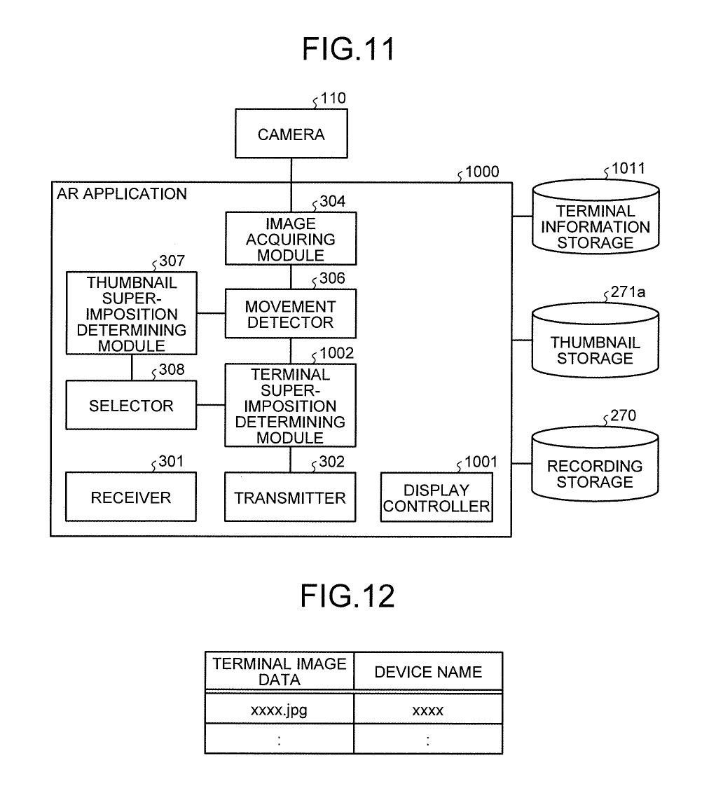

FIG. 11 illustrates a software configuration achieved when an AR application 1000 is performed by the controller 205 in the second embodiment. The AR application 1000 according to the second embodiment differs from the AR application 205d according to the first embodiment described above in that the terminal determining module 305 and the extractor 310 are eliminated, the display controller 303 is replaced by a display controller 1001 that performs different processing from that performed by the display controller 303, and the terminal superimposition determining module 309 is replaced by a terminal superimposition determining module 1002 that performs different processing from that performed by the terminal superimposition determining module 309. In the description below, like or corresponding parts are identified by the same reference numerals as those used in the first embodiment and detailed descriptions thereof will be omitted. In addition, the storage 271 according to the second embodiment further stores a terminal information storage 1011.

FIG. 12 illustrates a table structure of the terminal information storage 1011 according to the second embodiment. As illustrated in FIG. 12, the terminal information storage 1011 stores therein terminal image data and device names in association with each other. In a network according to the second embodiment, an IP address can be acquired from the device name. The terminal image data is used to represent a communication device capable of transmitting program content.

The display controller 1001 controls display of the display 211 via the video processor 210 as in the first embodiment. The display controller 1001 in the second embodiment differs from the display controller 303 of the first embodiment in that the display controller 1001 reads terminal image data stored in the terminal information storage 1011 to thereby display the exemplary screen illustrated in FIG. 10 in which the terminal image data is disposed.

As such, the television display device 900 according to the second embodiment is described for a case in which devices to which the program content is to be transmitted are registered in advance.

The terminal superimposition determining module 1002 determines whether a coordinate value representing the position of a person's hand detected by the movement detector 306 is included in the terminal image data while thumbnail image data is displayed as being moved in response to the movement of the person's hand.

When the coordinate value representing the position of the person's hand is determined to be included in the terminal image data, the transmitter 302 transmits program content that is represented by the thumbnail image data displayed as being moved in response to the movement of the person's hand to a communication terminal having a device name associated with the terminal image data in question.

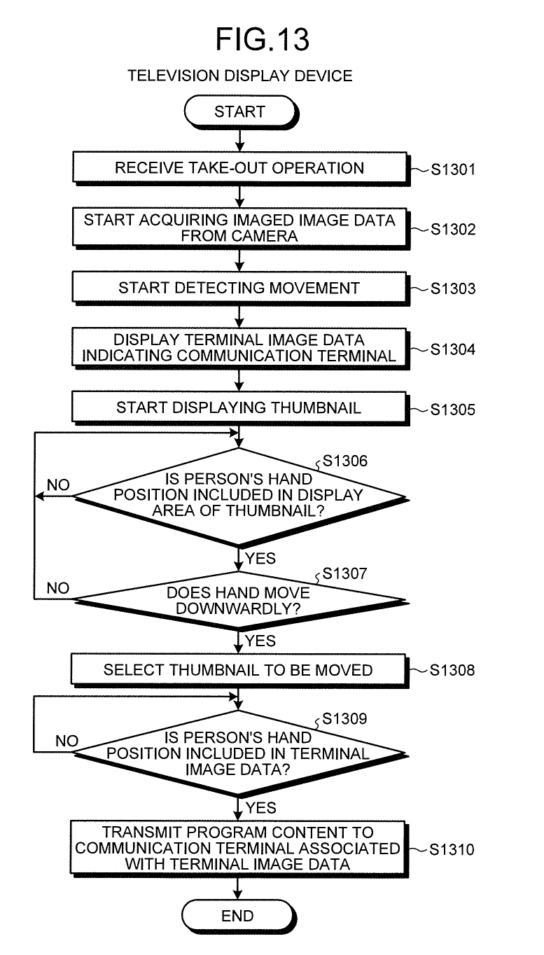

Processing to be performed when the program content is transmitted from the television display device 900 to the tablet terminal 150 according to the second embodiment will be described below. FIG. 13 is a flowchart illustrating a process followed by the television display device 900 in the second embodiment to transmit the program content.

The television display device 900 first receives an operation to start take-out (S1301). It is noted that, as in the first embodiment, a take-out request may be received from, for example, the tablet terminal 150.

Next, the television display device 900 starts the camera 110 as well as the AR application 1000. The camera 110 then shifts into a state for imaging a front surface area of the television display device 900.

The image acquiring module 304 of the AR application 1000 starts acquiring imaged image data from the camera 110 (S1302).

Then, the movement detector 306 starts detecting a movement of a person's hand based on the imaged image data (S1303).

Subsequently, the display controller 1001 reads the terminal image data from the terminal information storage 1011 and starts displaying the terminal image data indicating the communication terminal superimposed on the bottom part of the imaged image data (S1304).

Additionally, the display controller 1001 reads the thumbnail image data from the thumbnail storage 271a and displays a list of the thumbnail image data superimposed on the upper part of the imaged image data (S1305).

Then, the thumbnail superimposition determining module 307 determines whether a coordinate value indicating the position of the person's hand detected is included in a display area of the thumbnail image data (S1306). If the coordinate value is not included (No at S1306), the process of S1306 is performed again.

By contrast, if the thumbnail superimposition determining module 307 determines that the coordinate value indicating the position of the person's hand detected is included in the display area of the thumbnail image data (Yes at S1306), the movement detector 306 determines whether the person's hand detected moves downwardly (S1307). If the person's hand detected does not move downwardly, for example, if the person's hand detected moves laterally (No at S1307), the process is performed again starting with S1306. It is noted that the person's hand may be gripping instead of moving downwardly.

By contrast, if the movement detector 306 determines that the person's hand detected moves downwardly (Yes at S1307), the selector 308 receives the thumbnail image data that last included the coordinate value indicating the position of the person's hand at S1306 for selection as an object to be moved (S1308). This allows the user to select the content from the list of the thumbnail image data.

Subsequently, the terminal superimposition determining module 1002 determines whether the coordinate value indicating the position of the person's hand detected by the movement detector 306 is included in the display areas of the terminal image data items 901 and 902 (S1309). If the terminal superimposition determining module 1002 determines that the coordinate value is not included (No at S1309), the process of S1309 is performed again.

By contrast, if the terminal superimposition determining module 1002 determines that the coordinate value indicating the position of the person's hand is included in the display areas of the terminal image data items 901 and 902 (Yes at S1309), the transmitter 302 transmits to the communication terminal the program content indicated by the thumbnail image data received for selection by the selector 308 (S1310). The communication terminal to which the program content is to be transmitted is indicated by a device name associated with the terminal image data in question.

As such, the second embodiment can achieve a similar effect as that achieved by the first embodiment even with the communication terminal not imaged by the camera 110.

In the television display device according to the second embodiment described above, the imaged image data imaged by the camera 110 is displayed, which displays both an image of the user who is operating and the program content being operated, superimposed one over the other on the screen. This allows the user to recognize visually a specific operation he or she is performing, thus facilitating an intuitive understanding.

In addition, the user can not only operate the program content stored in the television display device, but also transfer the program content to the communication terminal such as the tablet terminal. This facilitates use of the television display device and the communication terminal.

The AR application executed on the television display device according to the second embodiment described above is provided in a file in an installable or executable format, recorded in a computer-readable recording medium such as a CD-ROM, a flexible disk (FD), a CD-R, or a digital versatile disk (DVD).

Preferably, the AR application executed on the television display device according to the second embodiment described above may be configured so as to be stored in a computer connected to a network such as the Internet and provided through downloading via the network. The AR application executed on the television display device according to the second embodiment described above may still be configured so as to be provided or distributed over a network such as the Internet.

Alternatively, the AR application of the second embodiment described above may be configured so as to be incorporated in, for example, a ROM in advance and provided.

The AR application executed on the television display device according to the second embodiment described above is configured as modules including the different modules described earlier. In an actual operation as hardware, the CPU (processor) reads the AR application from the above-described recording medium and executes the AR application to thereby load and create the different modules on the RAM 205b.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
an acquiring module configured to acquire, from an imaging device that images an object, imaged image information;
a display controller configured to display the imaged image information acquired by the acquiring module, including thumbnail image information that indicates first data and a first display area that represents a communication device to which data can be transmitted from the display device;
a detector configured to detect a movement of a first object imaged by the imaging device based on the imaged image information acquired by the acquiring module;
a selector configured to receive selection of the thumbnail image information;
a first determining module configured to determine whether a first coordinate value that indicates the first object, the movement of which is detected by the detector, is included in the first display area; and
a transmitter configured to transmit the first data indicated by the thumbnail image information, the selection of which is received by the selector, to the communication device represented by the first display area if the first determining module determines that the first coordinate value is included in the first display area.

2. The display device of claim 1, further comprising:
a receiver configured to receive, from the communication device, identification information that identifies the communication device on a network and characteristic information that indicates a characteristic of appearance of the communication device; and
a device determining module configured to determine whether a second object imaged in the imaged image information is the communication device based on the imaged image information acquired by the acquiring module and the characteristic information received by the receiver, wherein
if the device determining module determines that the second object is the communication device, the first determining module is configured to determine that a second display area in which the second object is imaged is the first display area that represents the communication device; and
the transmitter is configured to transmit the first data to the communication device identified by the identification information.

3. The display device of claim 1, further comprising:
a second determining module configured to determine whether a second coordinate value that indicates the first object, the movement of which is detected by the detector, is included in a third display area in which the thumbnail image information is displayed, wherein
prior to a determination made by the first determining module, the selector is configured to receive selection of the thumbnail image information of which the third display area is determined by the second determining module to include the second coordinate value.

4. The display device of claim 3, wherein if the detector detects a predetermined movement of the first object after the second determining module determines that the second coordinate value is included in the third display area of the thumbnail image information, the selector is configured to receive selection of the corresponding thumbnail image information.

5. The display device of claim 3, further comprising:
an extractor configured to extract, from the imaged image information acquired by the acquiring module, characteristic information indicating appearance of the communication device, wherein
the transmitter is further configured to transmit the characteristic information to the communication device.

6. An information transmission method executed by a display device, the information transmission method comprising:
acquiring, by an acquiring module, from an imaging device that images an object, imaged image information;
displaying, by a display controller, the imaged image information acquired by the acquiring module, including thumbnail image information that indicates first data and a first display area that represents a communication device to which data can be transmitted from the display device;
detecting, by a detector, a movement of a first object imaged by the imaging device based on the imaged image information acquired by the acquiring module;
first receiving, by a selector, selection of the thumbnail image information;
first determining, by a first determining module, whether a first coordinate value that indicates the first object, the movement of which is detected by the detector, is included in the first display area; and
transmitting, by a transmitter, the first data indicated by the thumbnail image information, the selection of which is received by the selector, to the communication device represented by the first display area if the first determining module determines that the first coordinate value is included in the first display area.

7. The information transmission method of claim 6, further comprising:
second receiving, by a receiver, from the communication device, identification information that identifies the communication device on a network and characteristic information that indicates a characteristic of appearance of the communication device; and
second determining, by a device determining module, whether a second object imaged in the imaged image information is the communication device based on the imaged image information acquired by the acquiring module and the characteristic information received by the receiver, wherein
if the device determining module determines that the second object is the communication device at the second determining, the first determining includes determining that a second display area in which the second object is imaged is the first display area that represents the communication device; and
the transmitting includes transmitting the first data to the communication device identified by the identification information.
